(19) United States
(12) Patent Application Publication
(10) Pub. No.: US 2014/0200981 A1
(43) Pub. Date: Jul. 17, 2014

(54) APPARATUS, SYSTEM AND METHOD FOR DYNAMIC DISCOUNTING AND PAYMENT PROCESSES

(71) Applicant: Newport Coast Investments, Irvine, CA (US)

(72) Inventor: Ryan Steelberg, Irvine, CA (US)

(21) Appl. No.: 14/157,006

(22) Filed: Jan. 16, 2014

Related U.S. Application Data
(60) Provisional application No. 61/753,296, filed on Jan. 16, 2013.

(51) Int. Cl. G06Q 30/02

(52) U.S. Cl. CPC G06Q 30/0238
USPC 705/14.26; 705/14.38; 705/14.35

(57) ABSTRACT

The present invention relates to providing a system for allowing coupon-based transaction, and, more particularly, to system and method for facilitating point-of-sale transaction based on the use of coupons.

### CROSS-REFERENCE TO RELATED APPLICATION

This application claims priority to U.S. Provisional Application No. 61/763,296, filed Jan. 16, 2013, entitled “Apparatus, System and Method for Dynamic Discounting and Payment Processes.

### FIELD OF THE INVENTION

The present invention relates to providing a system for allowing coupon-based transaction, and, more particularly, to system and method for facilitating point-of-sale transaction based on the use of coupons.

### SUMMARY OF THE INVENTION

The present invention may enable retail establishment to offer electronic transaction processing using existing point-of-sale hardware and software and may allow for the use of coupons for payment processing.

The present invention provides a computer-implemented system for a mobile, user-friendly payment processing solution which may be compatible with legacy infrastructure and modern forms of payment processes such as, for example, NFS, and other payment processing solution and platform, Paypal (with email and sms, and the like), Google, and Square. One major problem for existing retailers and legacy infrastructure is the inability to sync and or easily communicate with current alternative payment processing options. For example, retailers, such as Starbucks for example, are upgrading their point-of-sale systems to be able to use existing bar codes readers for not only product skews and coupons, but for payment processing. It is estimated that less than 10% (or far lower), of existing retailer systems can use bar code readers for payment processing.

The present invention may leverage the integrated, and near ubiquitous coupon functionality of point-of-service and bar code readers for payment processing and may facilitate product and/or retailer-based promotional campaigns, that may enable retailers, marketers, manufacturers to provides rebates, discounts, and the like, to consumers at point/time of transaction(s).

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods; and

FIG. 3 is a block diagram showing an exemplary method of the present invention.

### DETAILED DESCRIPTION

A computer-implemented platform and methods of use are disclosed that provide networked access to a plurality of payment processing types, including but not limited to coupon and virtual-coupon information that may allow for existing retail and service payment processing system to provide a mobile and/or personalized solution to payments and advertising, such as via one or more applications, or “apps.” Described embodiments are intended to be exemplary and not limiting. As such, it is contemplated that the herein described systems and methods can be adapted to provide many types of users with access and delivery of many types of payment options, and can be extended to provide enhancements and/or additions to the exemplary services described. The invention is intended to include all such extensions. Reference will now be made in detail to various exemplary and illustrative embodiments of the present invention.

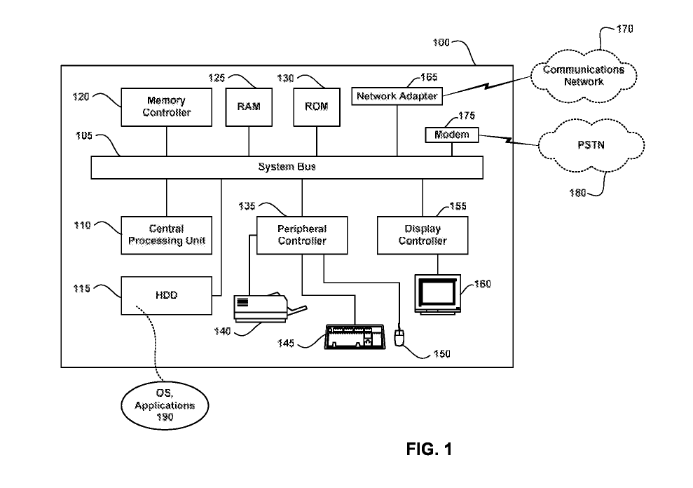

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

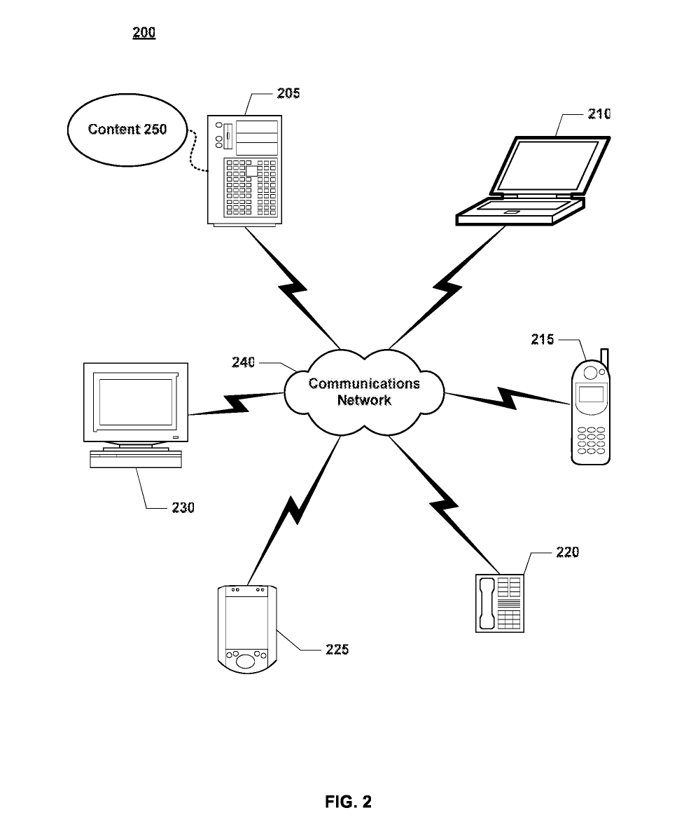

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

In an embodiment of the present invention, a user may access the present invention through a GUI and participate in platform which may allow a user to pay for services/goods provided through a coupon which may be scanned at the point of payment by a point-of-service (POS) system.

A clearing house form EDI, API, Web Services, and the like, may be integrated with at least one POS systems and/or Couponing Systems. Such integration may enable a clearing house to view, read, write, delete, add, etc. Coupon registration and skews into the present invention, such as through a retailer engine by, in part, tracking and utilizing user attributes. User attributes may include, for example, location, age and other demographics, frequency of system usage and/or purchasing of a particular service and/or good.

Within the present invention, a consumer may register with the provided clearinghouse, install an HTML or native mobile application, for example. A user may then create and/or register their account with any payment option or combination, including but not limited to Visa, Amex, Mastercard, Diners Club, Debit Card, eCheck, bank account, ACH and/or other known monetary transaction processing means (such as, for example, third party facilitators such as PayPal and Google Wallet).

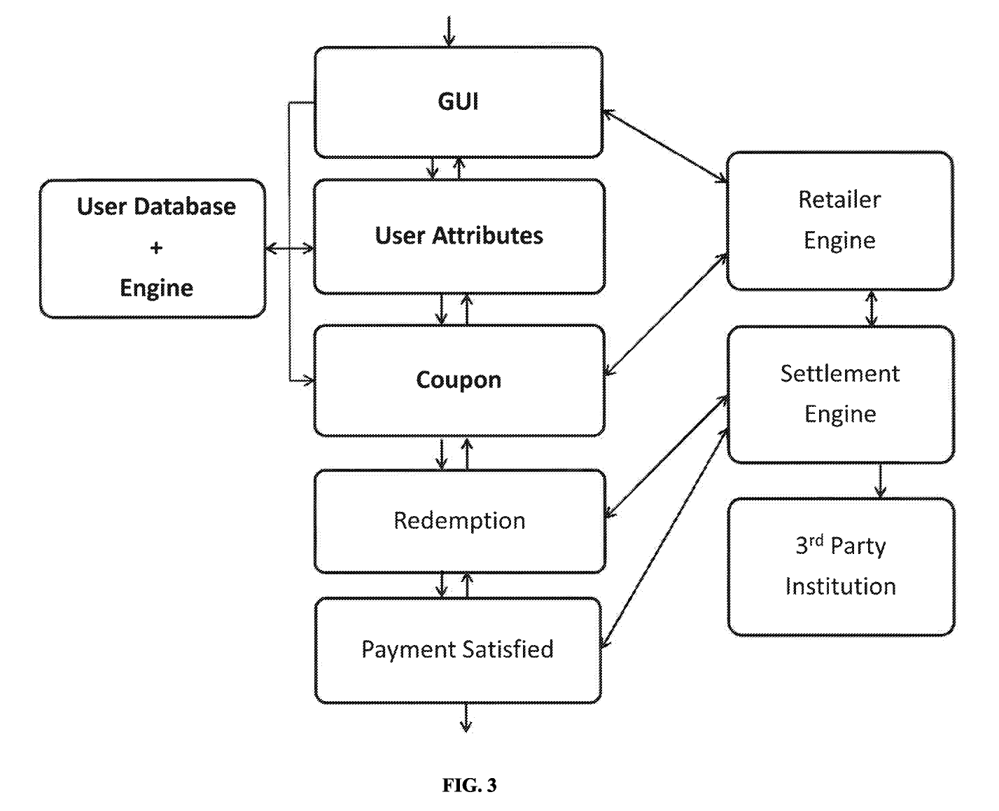

In an embodiment of the present invention, and as illustrated in FIG. 3, the consumer may shop at any store, that supports a coupon-enabled POS (which is majority). The user/consumer may take items to check out and have the store clerk process the transaction/purchase. When a total price is quoted (or before), for example, $101.25, a user/consumer may activate the present invention (which may be in the form of a mobile application) and enter in his/her personal code, PIN or other user identification (if such a code is required). The user may then request or have automatically generated for them, based on location metrics, for example, a new Dynamic Personal Coupon (DPC), for the specific purchase.

The DPC may allow for a default payment method or the user may select a specific payment method (Visa, Bank, AMEX, etc.). More specifically, such a request may be sent to a clearinghouse of the present invention which may allow for authorizing user, providing a payment ID/PIN, and transaction amount.

If, for example, the transaction is cleared, for example over payment ability and/or authorization of user, the clearinghouse of the present invention may, in real time. deliver back, or authorize the local (on consumer's smartphone, pda) display of DPC. This can be presented as a Promotion Code, QR Code, Bar Code or an NFC transmission. The DPC may equate to exactly the total purchase price and may include cash-back and/or gratuity, for example. Such DPC may have a half-life (10 seconds, up to 1 hour), which may be set by the present invention and/or store/retailer. The present invention may cancel or control the active nature of the DPC, down to single redemption, time or time-independent, for example.

As further illustrated in FIG. 3, a retailer may scan the DPC, which may fulfill (account for), the total purchase price of the goods/services received by the payor. Depending on the POS system in use, the DPC redemption may be sent back by the retailer, for example, to the present invention which in turn may distribute payment directly to the retailer. If the POS system is older, for example, the retailer may manually type in their 5-6 digit retailer code, or other identification code, directly the present invention (such as on a retailer specific application, for example, on a PDA) which may provide payment location/sync.

There are numerous derivatives to this invention, but the primary unique and novel idea is to leverage a dynamic, personal, digital couponing system, to provide a scalable and open payment platform, potentially able to work with any smartphone or POS system.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented system for facilitating coupon-based transactions, comprising:
a non-transitory computer readable storage medium having encoded thereon computer executable instructions for providing a graphical user interface capable of providing at least one user with access to at least one coupon, the coupon comprising at least product information and a transaction identifier;
a remote retailer engine capable of querying third party retailers on a network for product-related information related to a product indicated by the product information; and
at least one network port capable of remotely receiving via the network the product information from said graphical user interface, and the product-related information related to the product from the third party retailers;
wherein the at least one coupon may be read by at least one point-of-service machine of at least one the third party retailers for redemption of the product indicated by the product information.

2. The system of claim 1, wherein the at least one coupon is valid for a predetermined period of time.

3. The system of claim 1, wherein the at least one coupon comprises one selected from the group consisting of a promotion code, a QR code, and a bar code.

4. The system of claim 1, wherein additional redemption value is added to the coupon for redemption against service provided by ones of the at least one the third party retailers.
